(19) United States
(12) Patent Application Publication
(10) Pub. No.: US 2008/0221977 A1
(43) Pub. Date: Sep. 11, 2008

(54) Method for Statistical Process Control for Data Entry Systems

(75) Inventors: John W. Dawson, Scottsville, NY (US); E. Todd Johnsson, Fairport, NY (US); K. Bradley Paxton, Webster, NY (US)

Correspondence Address: Stephen B. Salai, Esq.;Harter, Secrest & Emery LLP, 1600 Bausch & Lomb Place, Rochester, NY, 14604-2711, US

(73) Assignees: ADI, LLC, Rochester, NY (US); EXACTDATA, LLC, Scottsville, NY (US)

(21) Appl. No.: 12/040,895

(22) Filed: Mar. 2, 2008

Related U.S. Application Data
(60) Provisional application No. 60/892,656, filed on Mar. 2, 2007.

(51) Int. Cl. G06F 11/34

(52) U.S. Cl. 705/11

(57) ABSTRACT

A method for integrated or Web based statistical process control of a data capture/data entry system we call AIMED@Q SPC™ (“Automatic Integration and Management of Enterprise Data Quality—Statistical Process Control”). Test images of machine print, handprint, or cursive writing, created through Digital Test Deck® technology or other methods, are injected into current workflows and keyed by Data Entry operators. Keyer results are quickly and cost-effectively compared to a perfectly known truth file corresponding to the test images. Reporting and analysis may be performed on single events or over time, at single or multiple locations.

### CROSS-REFERENCE TO RELATED APPLICATIONS

This application claims the benefit of U.S. Provisional Application No. 60/892,656, filed Mar. 2, 2007, which application is hereby incorporated by reference.

### TECHNICAL FIELD

The invention relates to forms processing (including bank checks), human data entry from image or paper, and related recognition technologies (e.g., OCR, ICR, OMR), and to the resulting data and performance quality evaluations of such data.

### BACKGROUND OF THE INVENTION

Many Data Entry, training, and Keyer Certification processes today utilize machine print for keyer evaluations. However, only a small percentage of the actual data entry work is machine print, with the majority being handprint or cursive writing. Enabled through special test materials, such as a Digital Test Deck®, available from ADI, LLC of Rochester, N.Y., this invention will allow certifications and training to exactly replicate actual keying requirements through a near-perfect simulation. Keyer-to-Keyer, team-to-team and site-to-site benchmarking is now enabled. Closed-loop processes for improvement are also enabled, such as tailored training for correcting the specific errors made by Keyers during production.

Data Entry Keying quality operations today, whether they are keying corrections from scanning recognition systems or just keying completely from paper, are applying 1) brute force quality (redundant keying) into data at a high operational cost and 2) sampling from production, determining truth through a slow and costly double key and verify process and then comparing to the production process results to generate an error measurement to ensure error rates are within specification.

Central to this invention is the ability to create or engineer the testing objects, simulating real production data including machine print, handprint and cursive writing (such as a Digital Test Deck®), and leverage its inherent perfectly known truth cost-effectively in near-real time. By injecting this “engineered test material” into the production process, one can statistically qualify the data quality of the production data capture process, specifically, the highly variable Error Rate of the human keying/correction process. The process can be managed and monitored with the capability to react appropriately to a signal in near-real time, for example when the data entry is “out of control”, along with elemental data (e.g., Error—Image Snippet mapping) to enable root cause analysis when corrective action is required to regain process control, or improvement action is desired for tighter specification limits. Again, this approach manages quality through process control, not brute forcing quality through redundant processing, which is the current standard for Data Entry operations today.

Statistical Process Control for manufacturing operations has been in place for quite some time now, but its application to Forms Data Capture incorporating special test materials for which the truth is known is new and potentially transforming for the industry. This capability has not been available to the industry to date due at least in part to not having “perfectly known truth in real time”, a capability that can be enabled through the use of Digital Test Deck® technology applied as taught by this invention. If convenient, handprint field snippets for which the truth has been otherwise determined may also be used.

The invention is preferably practiced by incorporation of a Digital Test Deck®, such as described in the filed and published U.S. patent application Ser. No. 10/933,002 for HANDPRINT RECOGNITION TEST DECK, which is hereby incorporated by reference. This application was published on Mar. 2, 2006 under the publication number US 2006/0045344 A1.

The integration of this method into the client's existing data capture system for overall system evaluation is taught in our contemporarily filed US patent application for PROCESS PERFORMANCE EVALUATION FOR ENTERPRISE DATA SYSTEMS, filed on even date herewith based on U.S. Provisional 60/892,654, which contemporary application is hereby incorporated by reference.

### SUMMARY OF THE INVENTION

AIMED@Q SPC™, a trade name of ADI, LLC of Rochester, N.Y., applied herein in connection with preferred practices of this invention, contains methods to implement statistical process control and certification programs for Data Entry Operations. (This name, as used herein, stands for “Automatic Integration and Management of Enterprise Data Quality—Statistical Process Control”). Test images efficiently created using Digital Test Deck® technology, for which the truth is perfectly known, would be injected into current workflows and keyed by humans. Keyer results would be compared to this perfectly known truth file for scoring purposes.

Implementation could be through a Web based solution or direct integration into current legacy systems. For a Web based solution, images would be directed and routed to Keyers through a central processing hub, with appropriate integration into current customer workflows. Reporting and analysis would then be performed on single events or over time to be applied in numerous ways advantageous to the clients of the data capture system.

A significant aspect of this invention is to implement Statistical Process Control for Data Entry Operations at the organizational or Keyer level to insure higher quality output data, at the same time eliminating slow and costly QA audit and inspection processes for only a 10% (or less) keying burden.

Another advantage of this invention is to enable root cause failure analysis and a closed feedback loop for data entry improvements, enabling realistic Continuous Process Improvement for human data entry.

Another aspect is the ability to evaluate competitive data entry bids in a systematic and factual fashion with sufficient quantities of realistic data, even remote or offshore approaches using the internet.

In another application of this invention, Keyer and/or Supplier Certification may easily be obtained whether for machine print, handprint, or cursive writing within the customer's user interface at the Keyer, team, and site or system level. This can reduce data capture system costs by improving hiring, reducing keyer turnover, and removal of the root cause of errors even before production begins.

After certification, this invention may be used to evaluate Keyer performance to determine on-going training requirements within the customer's user interface at the Keyer, team, and site level.

Overall, using our invention in one or more of its various aspects is expected to result in lower cost, higher quality data entry operations.

### BRIEF DESCRIPTION OF THE DRAWING FIGURES

FIG. 1 depicts a conceptual architecture of a web-based implementation of the invention.

FIG. 2 depicts a conceptual architecture of a solution integrated into an Enterprise Content Management System.

FIG. 3 is graph providing an example of statistical process control applied to data capture keyers showing error rate bands over time and resultant volume for a statistical process control implementation, with a 10% sampling rate on an hourly basis (e.g., 131 fields per hour), assuming a 1.5% average Keyer error and 95% confidence limits.

### DETAILED DESCRIPTION OF THE INVENTION

### Keyer and Supplier Certification

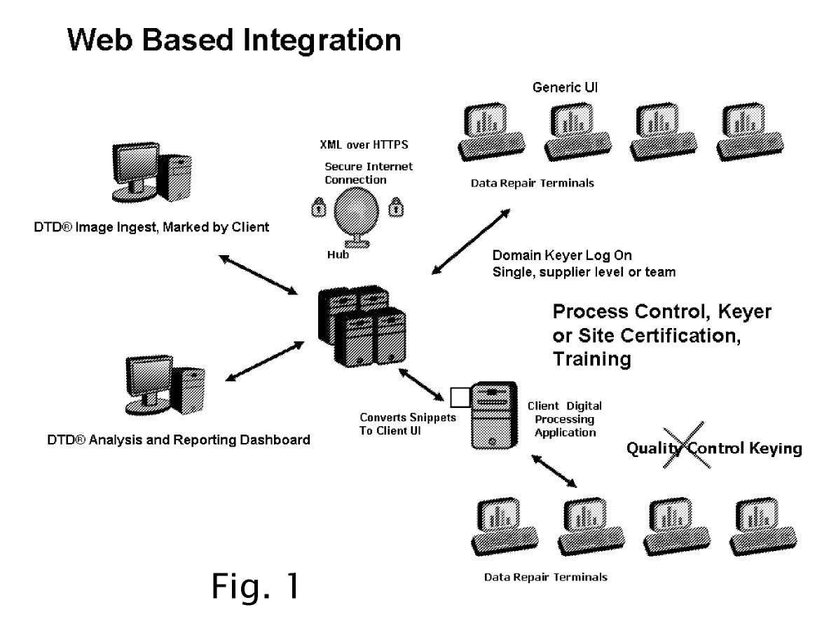

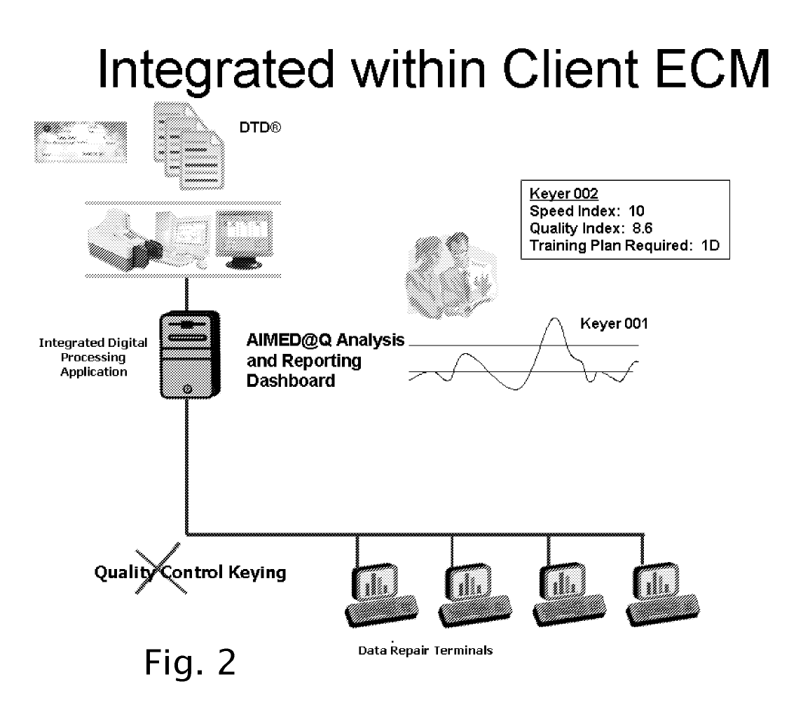

From a generic user interface, Keyers would log on and be provided test image snippets for keying. Speed, accuracy, and other metrics would be captured from the Keyer. Once the Keyers have completed the test work, reports would be prepared and made available as part of a web based system interface (see FIG. 1), or the current workflow (see FIG. 2).

For implementations using a custom user interface, such as the current operations user interface, ingested test snippets would be converted to the custom user interface at the operations digital processing application server. Keyers would log on and be provided image snippets for keying, displayed with the custom user interface. Speed, accuracy and other metrics would be captured from the Keyer. Once the Keyers have completed the test work, reports would be prepared and made available as part of a web based system interface (See FIG. 1), or the current workflow (see FIG. 2).

### Training Tailored to Test Results

Depending on the nature of the digitally created test handprint, e.g., cursive writing or machine print image snippets, Keyers can be stressed to failure or Keyer error under more normal conditions analyzed to determine opportunity areas for improvement. Training rules could be simulated to feed the keyer image snippets tailored to develop and test these opportunity areas.

### Closed Loop System for Continuous Improvement

With properly created digitally created test handprint, e.g., cursive or machine print image snippets, Keyers or other parts of the system can be stressed to failure or analyzed to determine opportunity areas for implementation of continuous improvement processes. Digital Test Deck® technology helps allow for incorporating engineered respondent “mistakes” and the creation of virtually any type of image quality error that might be seen in an image processing chain. The nature of Digital Test Deck® technology also helps to enable a closed loop evaluation after a process improvement implementation to determine and verify what if any impact the change has had on the Keyer, recognition subsystem or the entire system.

### Implementation of Statistical Process Control for Data Entry Operations at the Organizational or Keyer Level

Test images created through Digital Test Deck® technology or other methods would be injected into current workflows and keyed at a specified timing cadence. Keyer results would be compared to a perfectly known truth. With a web enable implementation, the system could be managed from a centralized hub (please note drawing for a Web Enabled Implementation, FIG. 1). The algorithms could also be integrated into the system workflow, along with the systematic ingest and processing of test images or material (please note drawing for an Integrated System, FIG. 2).

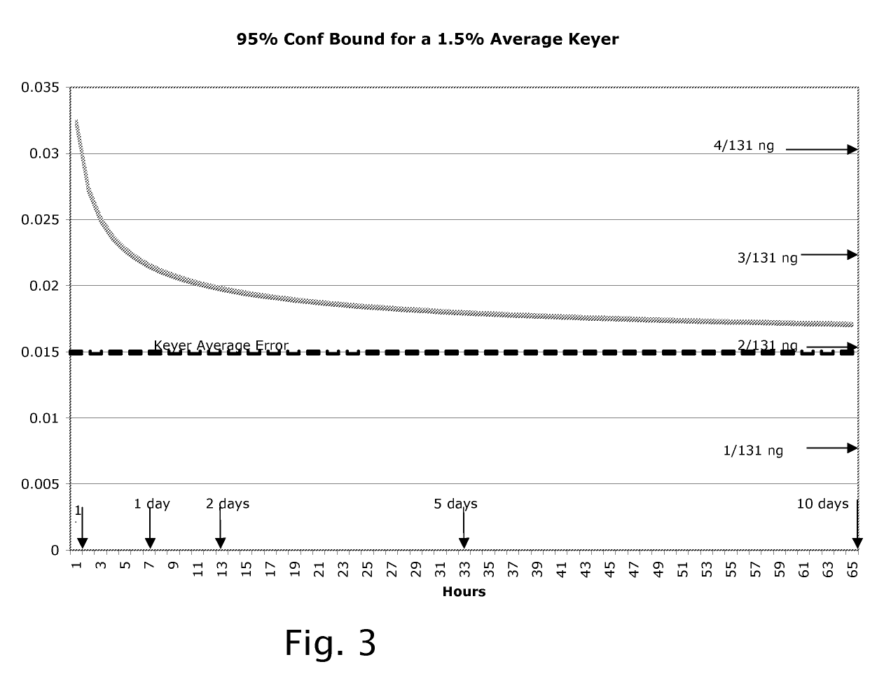

Here we describe an example of using statistical sampling for implementation of Statistical Process Control in a Data Entry System (See graph in FIG. 3). In this example, the keyers are keying simple fields (e.g., a check courtesy amount), such that their average error rate is 1.5% at the field level. This example uses a 10% sampling premium, so assuming 40K characters per day, 4.7 characters per field, 6.5 hours per day, this gives 131 snippets per hour being presented to each keyer for which we know the correct answers, that is, the “truth”.

Even using hourly sampling, we may obtain some useful information. As seen from FIG. 3, if a keyer is an average 1.5% error rate keyer, they might produce from zero to four errors in the sample of 131 fields due to sampling error and still be considered acceptable at 95% confidence. However, a keyer who produced more than four errors in the sample of 131 fields would not. For example, a keyer who produced six errors out of 131 fields would be suspect. One could continue this hourly sampling, and use that data to quickly identify problem keyers.

One can then also keep a rolling tab through next hour(s), building sample size (and thus confidence) in order to be more refined in the identification of keyers who are not performing well. For example, in four hours, there would be 524 fields sampled. In this case, if a keyer had 16 errors out of 524, (equivalent to 4 out of 131), then that keyer could be identified as non-performing, and so on. One could then remove, train, or recertify the offending keyer. Using daily sampling, we could begin to be concerned with a keyer who had the equivalent of 3/131 errors, and using a five-day or ten-day rolling average, we could be very sure a keyer having errors equivalent to 3/131 was non-performing. There are many variations on this basic concept of Statistical Process Control that are well known in the art that may be applied here at the user's discretion; however, with only a 10% sampling rate, a very robust process can be used to assure keyer accuracy in production with this invention, since the input truth is known in advance.

Although the above description is given with respect to a preferred embodiment, one skilled in the art of forms processing data capture will employ various modifications and generalizations to meet specific system needs. For example, although basic forms are discussed above, this invention clearly applies to other types of documents, such as bank checks, shipping labels, health claim forms, beneficiary forms, invoices, and other types of printed forms. The type of data being captured, in addition to handprint, could also be machine print, cursive writing, marks in check boxes, filled-in ovals, MIRC font characters, barcodes, etc. The special test materials might include printed test decks, or in some cases, just the electronic “snippets” or images of these forms may suffice depending on specific test requirements. The special test materials for which the truth is known may preferably be used, and/or it is possible to employ double key and verify to estimate the “truth” of real production data if that is desired.

1. A method for measuring and characterizing forms processing data entry systems comprising steps of:
(a) inputting test materials containing sample data for which the truth is known,
(b) inputting system operating parameters for evaluating data entry performance,
(c) performing scoring and analysis of Keyed data, entered for matching the sample data of the test materials,
(d) employing date and time stamps associated with the sample data as part of content metadata, and
e) outputting Keyer error rates in near-real time.

2. The method of claim 1 where the test materials include electronic images.

3. The method of claim 1 including a step of implementing statistical process control into keying operations.

4. The method of claim 1 in which the step of performing scoring and analysis is performed for pre-screening a Keyer in advance of employing the Keyer.

5. The method of claim 1 including steps of determining if a Keyer's error rate is unacceptable and deploying corrective action.

6. The method of claim 1 including a step of integrating the method into a client's Legacy or Enterprise Content Management system.

7. The method of claim 1 including a step of implementing the method as a web-based solution.

8. A method for statistical process control for data entry systems comprising steps of:
injecting test images for which the truth is known in the form of a truth file into a current workflow for data entry keying, comparing keyer results to the truth file for test images keyed within the current workflow, and
capturing metrics measuring speed and accuracy for individual keyers based on the results of the comparison.

9. The method of claim 8 including a step of converting the test images into a custom user interface modeling other images of the workflow.

10. The method of claim 8 including steps of making an adjustment for improving keyer speed or accuracy and comparing result derived before and after the adjustment to determine if the adjustment improved keyer speed or accuracy.

11. The method of claim 8 in which the step of capturing metrics is performed contemporaneously with the keying of the individual keyers within the current workflow.

12. The method of claim 8 in which the injected test materials are injected as a limited percentage of materials within the current workflow.

13. The method of claim 12 in which the injected materials represent approximately 10 percent or less of the materials within the current workflow.
